(19) United States
(12) Patent Application Publication
(10) Pub. No.: US 2026/0259388 A1
(43) Pub. Date: Sep. 3, 2026

(54) OPTICAL DEVICE HAVING OCCULTER ARM MOVEABLE TO OCCLUDE THE FIELD OF VIEW AND ASSOCIATED METHODS

(71) Applicant: Eagle Technology, LLC, Melbourne, FL (US)

(72) Inventors: Aidan BRAWLEY, Reading, MA (US); David DRISCOLL, Andover, MA (US); Paul Richard OUELLETTE, North Andover, MA (US); Joel SHAKLEE, Brookline, NH (US)

(21) Appl. No.: 19/066,238

(22) Filed: Feb. 28, 2025

(51) Int. Cl. G02B 7/00; G02B 27/00; G03B 11/04

(52) U.S. Cl. CPC G02B 7/005; G02B 27/0012; G03B 11/04

(57) ABSTRACT

An optical device may include a tubular body defining a field-of-view (FOV). A first slew ring bearing may be carried by the tubular body. A second slew ring bearing may be carried by the first slew ring bearing. An occulter arm may be selectively movable by the first and second slew ring bearings for occluding a selected portion of the FOV.

### GOVERNMENT LICENSE RIGHTS

This invention was made with U.S. government support. The government has certain rights in the invention.

### FIELD OF THE INVENTION

The present invention relates to the field of optical devices, and, more particularly, this invention relates to optical devices that occlude a selected portion of an optical field-of-view (FOV) and related methods.

### BACKGROUND OF THE INVENTION

When imaging a known bright light source in the background, e.g., the sun, a typical coronograph or similar optical device may incorporate a static occulter at its front end to block the stray light and allow for imaging of objects around the light source circumference, such as solar flares. For example, a telescopic attachment may block out direct light from a star, the sun or other bright object, allowing nearby objects that would otherwise be hidden in the object's bright glare to be resolved. Thus, the corona of the sun may be viewed, and in some advanced coronagraphs, the light from nearby stars may be blocked to view extrasolar planets, circumstellar disks around nearby stars, and host galaxies in quasars.

Some coronographs are designed for imaging the sun's outer atmosphere, but are not configured to enable imaging of objects that may pass through or around it. The occulter in many coronographs and similar optical devices is usually static, and designed for the light source to be always centered on the optical system when imaging. Some optical devices incorporate a baffle where a strong light source outside a camera field enters the surface of an optical detector through multiple reflection points, and scatters to lessen the impact of the strong light. Other optical devices incorporate an off-axis parabolic primary mirror near an entrance aperture that images a solar disk and the corona on a convex secondary mirror, which has a cone-shaped hole to ensure the solar disk light passes through and enters a light trap. The coronal light remains and is reflected from the secondary mirror to an off-axis third mirror. The system has drawbacks because it is still static.

In another telescope occulter design, a static imaging stop is placed in the conjugate plane to deflect light, and a beam splitter separates the corona and white light. Other optical devices may incorporate a lens cell that optimizes stray light rejection in an aspherical airborne camera, and incorporate baffles to reduce the impact of stray light on the camera imaging. Software may be used to analyze the stray light and establish a mathematical model based on the scattering intensity measurement. These are also static systems and often require complex and sophisticated software.

Many of these coronagraphs and similar optical devices do not have the ability to correct for movement of a light source across the focal plane. Instead, these devices rely on vehicle positioning alone to keep the imaging system viable. If it is desirable to look at objects passing by the light source while the spacecraft is also moving without correction for the optical system, a dynamic occulter mechanism may be required to actively block the light source through the focal range of motion while maintaining image clarity.

### SUMMARY OF THE INVENTION

An optical device may comprise a tubular body defining a field-of-view (FOV). A first slew ring bearing may be carried by the tubular body, and a second slew ring bearing may be carried by the first slew ring bearing. An occulter arm may be selectively movable by the first and second slew ring bearings for occluding a selected portion of the FOV.

A first drive may be fixed to the tubular body and coupled to the first slew ring bearing. The first slew ring bearing may comprise a first inner ring fixed to the tubular body, and a first outer ring coupled to the first drive and the second slew ring bearing. A second drive may be fixed to the tubular body and coupled to the second slew ring bearing. The second slew ring bearing may comprise a second inner ring coupled to the first slew ring bearing and a second outer ring coupled to the second drive. The occulter arm may comprise a proximal end pivotably coupled to the second inner ring and rotated by relative movement between the second inner ring and second outer ring. The occulter arm may comprise a distal end and an occulter disk coupled thereto.

The second slew ring bearing and the occulter arm may each have respective detent features to retain the occulter arm in a stored position. A first drive may be associated with the first slew ring bearing, and a second drive may be associated with the second slew ring bearing. A controller may be coupled to the first and second drives. An optical detector may be coupled to the tubular body.

Another aspect is directed to a method for occluding a selected portion of a field-of-view (FOV) defined by a tubular body of an optical device. The method may comprise operating a first slew ring bearing carried by the tubular body, and operating a second slew ring bearing carried by the first slew ring bearing so that an occulter arm operatively coupled to the first and second slew ring bearings is selectively moved for occluding the selected portion of the FOV.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is an isometric view of the optical device showing the occulter arm that is selectively moveable by first and second slew ring bearings according to the invention.

FIG. 2 is another isometric view of the optical device of FIG. 1 showing a partial cut-away section removed.

FIG. 3 is a side view of the optical device of FIG. 1 incorporating a focal subassembly, controller, and optical detector.

FIG. 4 is an exploded isometric view of the optical device of FIG. 1.

FIG. 5 is a top operational view of the optical device showing the occulter arm in a first position at a first time period (t−1).

FIG. 6 is another top operational view showing the occulter arm in a second position at a second time period (t0).

FIG. 7 is another top operational view showing the occulter arm in a third position at a third time period (t+1).

FIG. 8 is a high-level flowchart of a method for occluding a portion of a field-of-view defined by the optical device.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

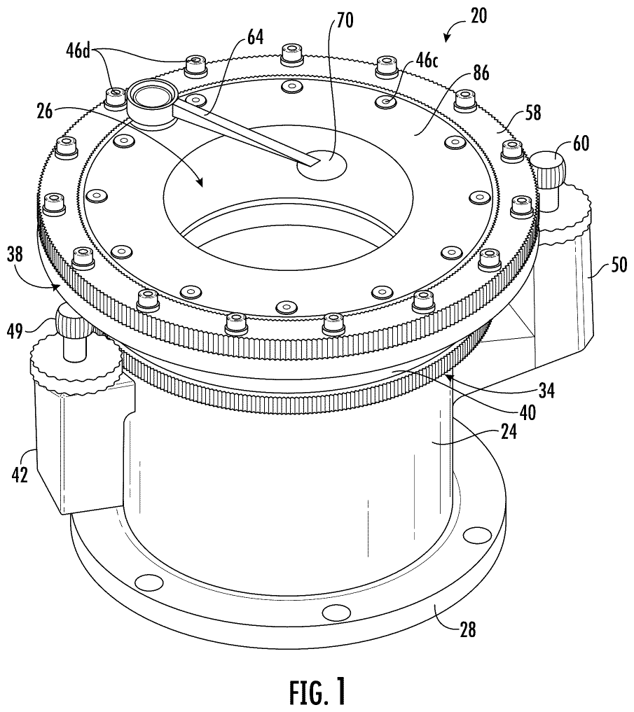

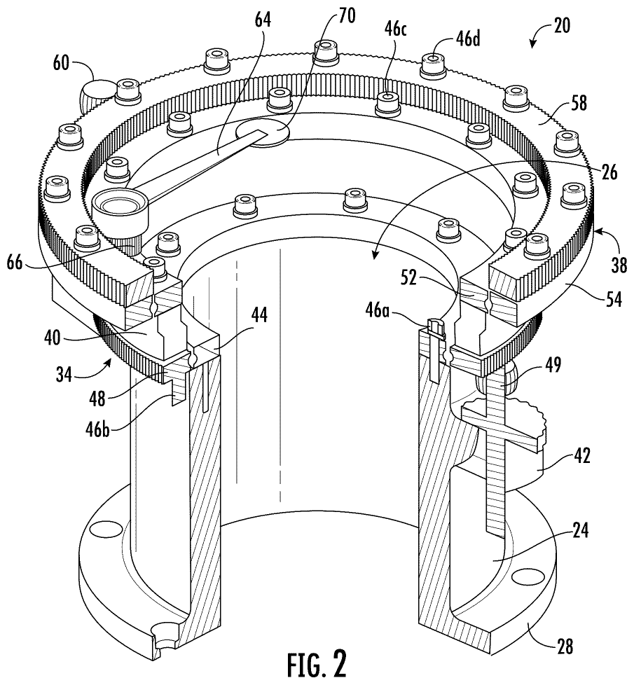

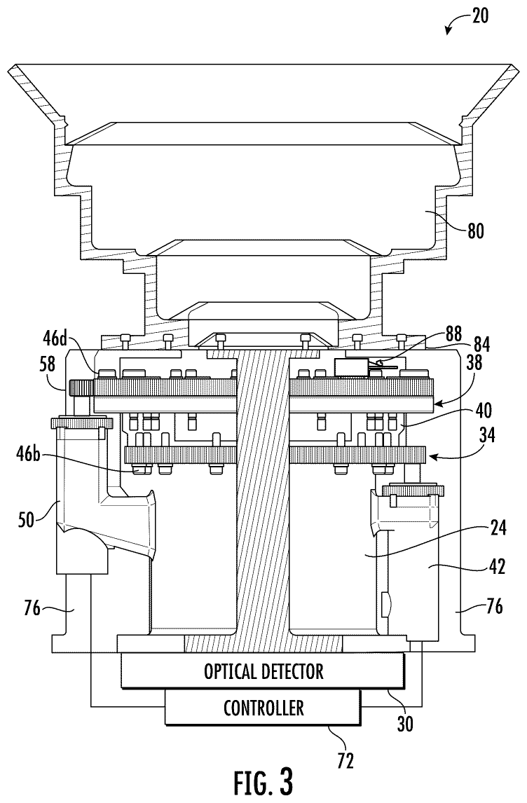

Referring initially to FIGS. 1-3, an optical device is shown generally at 20 and includes a tubular body 24 defining a field-of-view (FOV) shown by the arrow at 26. The tubular body 24 includes an outer mounting flange 28 at its lower end, permitting the optical device 20 to be mounted to a telescope frame or other optical imaging device such as an optical detector 30 coupled to the tubular body as explained in greater detail below with reference to FIG. 3. A first slew ring bearing 34 is carried by the tubular body 24, and a second slew ring bearing 38 is carried by the first slew ring bearing. An annular spacer 40 is interposed between the first and second slew ring bearings 34,38 as best shown in the partial cut-away section of FIG. 2 and the exploded isometric view of the optical device 20 of FIG. 4.

A first drive 42 is fixed to the tubular body 24 and coupled to the first slew ring bearing 34. The first slew ring bearing 34 includes a first inner ring 44 fixed to the upper section of the tubular body 24 by a first set of threaded fasteners 46a best shown in FIG. 2, and in the exploded isometric view of FIG. 4. The first slew ring bearing 34 also includes a first outer ring 48 coupled to the first drive 42 and the second slew ring bearing 38. A second set of threaded fasteners 46b extends upward through the first outer ring into the annular spacer 40, which is secured to the second slew ring bearing 38.

The first drive 42 includes a first drive gear 49 that engages gear teeth positioned on the outer perimeter of the first outer ring 48. A second drive 50 is fixed to the tubular body 24 and coupled to the second slew ring bearing 38. In this example, the second slew ring bearing 38 includes a second inner ring 52 coupled to the first slew ring bearing 34 via the annular spacer 40 and a third set of threaded fasteners 46c that extend from the second inner ring into the annular spacer. A second outer ring 54 is coupled to the second drive 50. As best shown in the partial cut-away section in FIG. 2 and the exploded isometric view in FIG. 4, an annular gear 58 is secured to the top section of the second outer ring 54 of the second slew ring 38 by a fourth set of fasteners 46d. A second drive gear 60 at the output of the second drive 50 engages gear teeth positioned on the outer perimeter of the annular gear 58.

An occulter arm 64 is selectively moveable by the first and second slew ring bearings 34,38 for occluding a selected portion of the FOV 26. The occulter arm 64 includes a proximal end pivotably coupled to the second inner ring 52 and rotated by relative movement between the second inner ring and second outer ring 54. As best shown in the broken sectional view of FIG. 2, the proximal end of occulter arm 64 is mounted on an occulter drive gear 66 that is rotatably mounted on the second inner ring 52. The occulter drive gear 66 engages internal gear teeth of the annular gear 58 secured to the top section of the second outer ring 54 of the second slew ring bearing 38. The occulter arm 64 includes a distal end and an occulter disk 70 coupled thereto.

A controller 72 (FIG. 3) is coupled to the first and second drives 42,50 and synchronizes their operation together. The first drive 42 controls the 360° positioning of the second slew ring bearing 38 having the occulter arm 64 pivotably attached. The second drive 50 controls the radial positioning of the occulter disk 70 coupled to the occulter arm via the inner gear connection at the annular gear 58, which is secured to the second outer ring 54 of the second slew ring bearing 38.

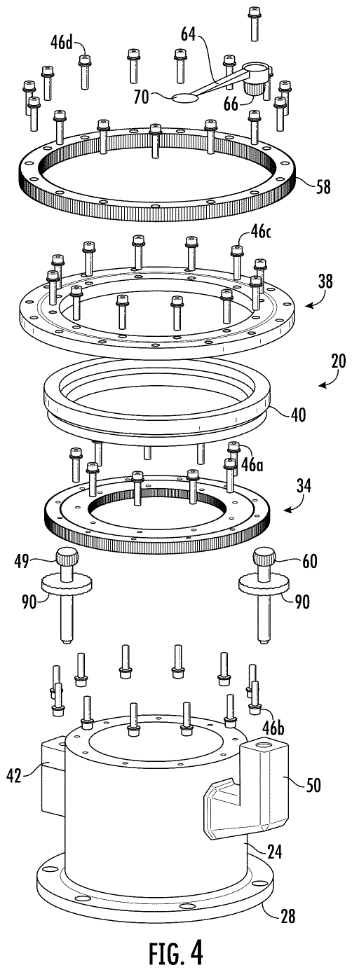

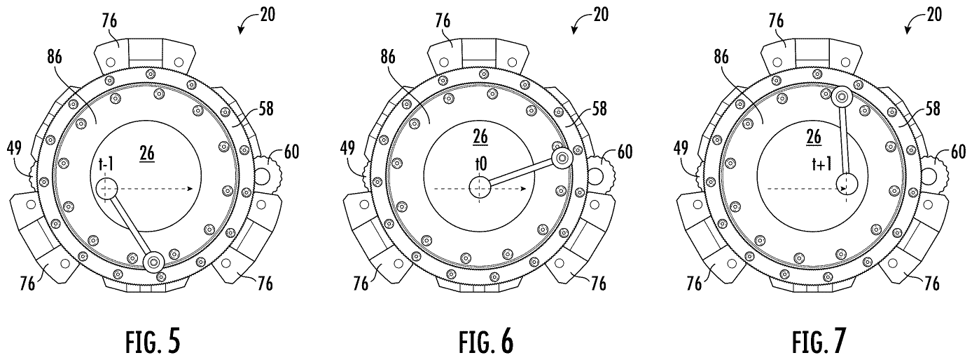

In operation, both the first and second drives 42,50 are driven via the controller 72 for specific movement of the occulter arm 64 and attached occulter disk 70 to occlude a selected portion of the field-of-view 26. A linear motion of the occulter disk 70 is provided in the field-of-view 26 as the first and second drives 42,50 operate together, such as shown in FIG. 5-7. A first initial position corresponding to time (t−1) of the occulter disk 70 is shown in FIG. 5. As the first and second drives 42,50 are operated via the controller 72, the occulter disk 70 moves linearly into the centered position in FIG. 6 corresponding to time (t−0), and then into the final position corresponding to time (t+1) shown in FIG. 7. The dashed line shows the time sequence and linear movement of the occulter disk 70 across the field-of-view 26.

Referring again to FIG. 3 and as shown in FIG. 5-7, three equidistant baffle mounts 76 are attached around the tubular body 24 and secure a focal subassembly 80 onto the top section of optical device 20. The optical detector 30 may be connected to the lower sections of the baffle mounts 76 and outer mounting flange 28, which may also secure the controller 72 that operates the first and second drives 42,50.

Baffle struts 84 are formed at the upper sections of the baffle mounts 76 and may be formed from titanium to thermally isolate heat from the optical device 20, the focal subassembly 80, and a lens cell housing 86 positioned at the upper end of the optical device as best shown in FIGS. 1 and 5-7. In this example, the lens cell housing 86 may include a 2 inch diameter field-of-view 26, and be formed as an insert that is received onto the second inner ring 52.

The focal subassembly 80 may be about 7½ inches high, in an example, and the length from the focal subassembly 80 to the lower section of the optical device 20 may be about 9 inches. The baffle mounts 76 may be formed to establish a rigid connection with a common ground point. The distance from the top portion of the baffle struts 84 to the lens cell housing 86 may be minimized to less than 0.5 inches, while still allowing for uninterrupted movement of the occulter arm 64 and the occulter disk 70 attached thereto. As best shown schematically in FIG. 3, the second slew ring bearing 38 and the occulter arm 64 each may have respective detent features 88 to retain the occulter arm in a stored position during transit, as on a rocket containing a satellite traveling into orbit or to avoid “hard stop” stowing. The detent features 88 may be incorporated within the first and second drives 42,50 however, such as magnetic detents included within stepper motors.

Different designs for the occulter arm 64 were tested with differing geometries, such as a conical mechanism with a varying cone angle, a toothed disk with varying teeth length and number, and an occulter disk of varying thickness. It was determined that an occulter disk 70, such as illustrated in FIGS. 1, 2, and 5-7, performed best after analyzing stray light test results. In an example, the first and second drives 42,50 may each be a stepper motor having 1,200 step output rotation with about a 0.3° rotation per step. The first and second drive gears 49,60 and occulter drive gear 66 may each have about 24 teeth and have a pitch diameter of about 0.34 inches as non-limiting examples. The first and second drives 42,50 may each have output shafts that include not only the respective first and second drive gears 49,60, but also mid-pinions 90 that may be used to engage a drive in other examples (FIG. 4).

The optical device 20 advantageously addresses the difficult task of actively blocking a solar stray light source over the entire field-of-view (FOV) 26 in an efficient and low-cost configuration using a dynamic occulter arm 64 at the virtual entrance pupil of any given lens cell. Because first and second drives 42,50 remain fixed to the tubular body 24, there is minimized rotational inertia on the optical device 20. The detent features 88 provide non-invasive detent retention of the occulter arm 64 during launch, and when not needed throughout mission life. The optical device 20 is fully compatible with existing, affordable lens designs.

The optical device 20 may be tailored for a variety of applications by changing the size of the occulter arm 64 and/or the first and second drives 42,50 and/or first, second and occulter drive gears 49,60,66 if warranted. The optical device 20 can be readily manufactured and provide fine control of the occulter arm 64 positioning via the first and second drives 42,50, formed in this example as two 1,200 step space-grade, stepper motors. The optical device 20 may be configured as a drop-in solution to existing space-borne telescopes and other optical systems, with few or no design changes for any optical satellite requiring an active occulter mechanism within about a 2 inch lens diameter. Larger applications can be met with minor modifications to the components, including the occulter arm 64 geometry. It is possible that the optical device 20 may be tailored for other applications outside of optical satellites and other applications in the space sector. For example, it may be possible to use the optical device 20 for active blocking of a laser source or apply the optical device to point-to-point laser communications to prevent cross contamination.

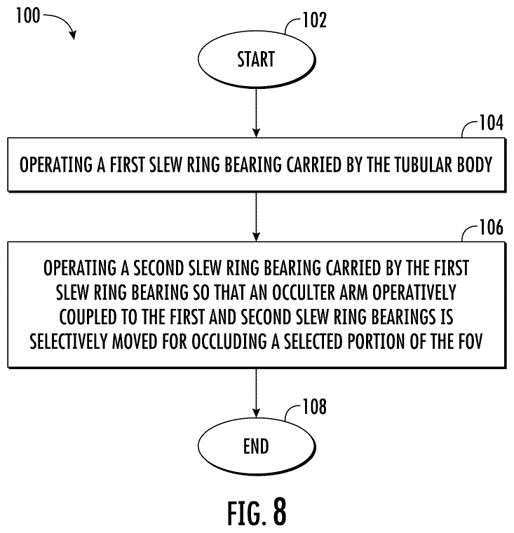

Referring now to FIG. 8, a high-level flowchart of a method for occluding a portion of the field-of-view (FOV) 26 defined by a tubular body 24 of an optical device 20, such as shown in FIG. 1-7, is generally illustrated at 100. The process starts (Block 102) by operating a first slew ring bearing 34 carried by the tubular body 24 (Block 104). The method includes operating a second slew ring bearing 38 carried by the first slew ring bearing 34 so that an occulter arm 64 operatively coupled to the first and second slew ring bearings is selectively moved for occluding a selected portion of the FOV 26 (Block 106). The process ends (Block 108).

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. An optical device comprising:
a tubular body defining a field-of-view (FOV);
a first slew ring bearing carried by the tubular body;
a second slew ring bearing carried by the first slew ring bearing; and
an occulter arm selectively movable by the first and second slew ring bearings for occluding a selected portion of the FOV.

2. The optical device of claim 1 comprising a first drive fixed to the tubular body and coupled to the first slew ring bearing.

3. The optical device of claim 2 wherein the first slew ring bearing comprises a first inner ring fixed to the tubular body, and a first outer ring coupled to the first drive and the second slew ring bearing.

4. The optical device of claim 1 comprising a second drive fixed to the tubular body and coupled to the second slew ring bearing.

5. The optical device of claim 4 wherein the second slew ring bearing comprises a second inner ring coupled to the first slew ring bearing and a second outer ring coupled to the second drive.

6. The optical device of claim 5 wherein the occulter arm comprises a proximal end pivotably coupled to the second inner ring and rotated by relative movement between the second inner ring and second outer ring.

7. The optical device of claim 1 wherein the occulter arm comprises a distal end and an occulter disk coupled thereto.

8. The optical device of claim 1 wherein the second slew ring bearing and the occulter arm each have respective detent features to retain the occulter arm in a stored position.

9. The optical device of claim 1 comprising:
a first drive associated with the first slew ring bearing;
a second drive associated with the second slew ring bearing; and
a controller coupled to the first and second drives.

10. The optical device of claim 1 comprising an optical detector coupled to the tubular body.

11. An optical device comprising:
a tubular body defining a field-of-view (FOV);
a first slew ring bearing carried by the tubular body;
a second slew ring bearing carried by the first slew ring;
a first drive associated with the first slew ring bearing;
a second drive associated with the second slew ring bearing;
an occulter arm coupled to the first and second slew ring bearings; and
a controller coupled to the first and second drives to selectively move the occulter arm for occluding a selected portion of the FOV.

12. The optical device of claim 11 wherein the first slew ring bearing comprises a first inner ring fixed to the tubular body, and a first outer ring coupled to the first drive and the second slew ring bearing.

13. The optical device of claim 12 wherein the second slew ring bearing comprises a second inner ring coupled to the first slew ring bearing and a second outer ring coupled to the second drive.

14. The optical device of claim 13 wherein the occulter arm comprises a proximal end pivotably coupled to the second inner ring and rotated by relative movement between the second inner ring and second outer ring.

15. The optical device of claim 11 wherein the occulter arm comprises a distal end and an occulter disk coupled thereto.

16. The optical device of claim 11 wherein the second slew ring bearing and the occulter arm each have respective detent features to retain the occulter arm in a stored position.

17. A method for occluding a selected portion of a field-of-view (FOV) defined by a tubular body of an optical device, the method comprising:
operating a first slew ring bearing carried by the tubular body; and
operating a second slew ring bearing carried by the first slew ring bearing so that an occulter arm operatively coupled to the first and second slew ring bearings is selectively moved for occluding the selected portion of the FOV.

18. The method of claim 17 comprising operating a first drive fixed to the tubular body and coupled to the first slew ring bearing.

19. The method of claim 17 comprising operating a second drive fixed to the tubular body and coupled to the second slew ring bearing.

20. The method of claim 17 wherein the second slew ring bearing and the occulter arm each have respective detent features to retain the occulter arm in a stored position.
